(19) United States
(12) Patent Application Publication
(10) Pub. No.: US 2023/0052213 A1
(43) Pub. Date: Feb. 16, 2023

(54) METHOD FOR SIMULATING AND ANALYZING BEHAVIORS OF CUSTOMERS IN A RETAIL ENVIRONMENT

(71) Applicant: AiFi Corp, Santa Clara, CA (US)

(72) Inventors: Ying Zheng, Santa Clara, CA (US); Steve Gu, santa Clara, CA (US); Long Chen, Santa Clara, CA (US); Joao Falcao, Santa Clara, CA (US)

(73) Assignee: AiFi Corp, Santa Clara, CA (US)

(21) Appl. No.: 17/399,187

(22) Filed: Aug. 11, 2021

(51) Int. Cl. G06Q 30/02; G06K 9/00

(52) U.S. Cl. CPC G06Q 30/0201; G06K 9/00335; G06Q 30/0281; G06Q 30/0269; G06Q 30/0224

(57) ABSTRACT

This application relates to systems, methods, devices, and other techniques that can be utilized to simulate and analyze behaviors of customers in a retail environment.

### BACKGROUND OF THE INVENTION

This application relates to systems, methods, devices, and other techniques that can be utilized to simulate and analyze behaviors of customers in a retail environment.

Methods and apparatus to generate models for testing and training neural networks in a retail store to monitor products and customers are in practice. However, generating customer behavior models by visual reality platforms within a retail environment is new. Furthermore, these techniques and methods can be combined with recently developed AI and machine learning and make the purchase process more accurate and efficient.

This application relates to systems, methods, devices, and other techniques that can be utilized to simulate and analyze behaviors of customers in a retail environment.

### SUMMARY OF THE INVENTION

In some embodiments, the invention is related to a method for analyzing the behavior of at least a person in a retail store, the method comprising: Identifying the person by the camera and relating to a membership number if the person is a member; capturing a plurality of videos and images of the person by a plurality of cameras; processing the plurality of videos and images to track the person in each field of view of the plurality of cameras; finding information for a trip of the person in the retail store based on the processing of the plurality of videos and images, wherein the information for the trip comprises time spent of the person at each shelf in the retail store, time the person spent to compare different items, time the person spent on certain category of products; providing information to the person on how to navigate in the retail store based on interest and previous trip by the person; providing dynamic pricing of items to the person based on shopping history of the person, current promotion of the items; highlighting the items by a specialized lighting to the person based on shopping history of the person and, the trip of the person in the retail store; analyzing the behavior of the person based on the trip information; and saving the behavior of the person and related to the membership number of the person.

In some embodiments, the invention is related to a method for analyzing the behavior of at least a person in a retail store, comprising, the method comprising: Identifying the person by the camera and relating to a membership number if the person is a member; capturing a plurality of videos and images of the person by a plurality of cameras; processing the plurality of videos and images to track the person in each field of view of the plurality of cameras; finding information for a trip of the person in the retail store based on the processing of the plurality of videos and images, wherein the information for the trip comprises time spent of the person at each shelf in the retail store, time the person spent to compare different items, time the person spent on certain category of products; providing information to the person on how to navigate in the retail store based on interest and previous trip by the person; providing dynamic pricing of items to the person based on shopping history of the person, current promotion of the items; highlighting the items by a specialized lighting to the person based on shopping history of the person and the trip of the person in the retail store; displaying the customized promotional discount to the person; and providing bakery smells by scent machines to the person if purchase history shows the person purchased bakery recently.

In some embodiments, the invention is related to a method for analyzing the behavior of at least a person in a retail store, comprising, the method comprising: Identifying the person by the camera and relating to a membership number if the person is a member; capturing a plurality of videos and images of the person by a plurality of cameras; processing the plurality of videos and images to track the person in each field of view of the plurality of cameras; finding information for a trip of the person in the retail store based on the processing of the plurality of videos and images, wherein the information for the trip comprises time spent of the person at each shelf in the retail store, time the person spent to compare different items, time the person spent on certain category of products; providing information to the person on how to navigate in the retail store based on interest and previous trip by the person; providing dynamic pricing of items to the person based on shopping history of the person, current promotion of the items; highlighting the items by a specialized lighting to the person based on shopping history of the person and the trip of the person in the retail store; analyzing the behavior of the person based on the trip information; and sending another set of promotions to the person based on the trip after the person left the store.

These and other aspects, their implementations and other features are described in detail in the drawings, the description and the claims.

### BRIEF DESCRIPTION OF THE DRAWINGS

FIG. 1 shows an example of a method for simulating and analyzing the behavior of at least a person in a retail store.

FIG. 2 shows an example of another method for simulating and analyzing the behavior of at least a person in a retail store.

FIG. 3 shows another example of a third method for simulating and analyzing the behavior of at least a person in a retail store.

### DETAILED DESCRIPTION OF THE INVENTION

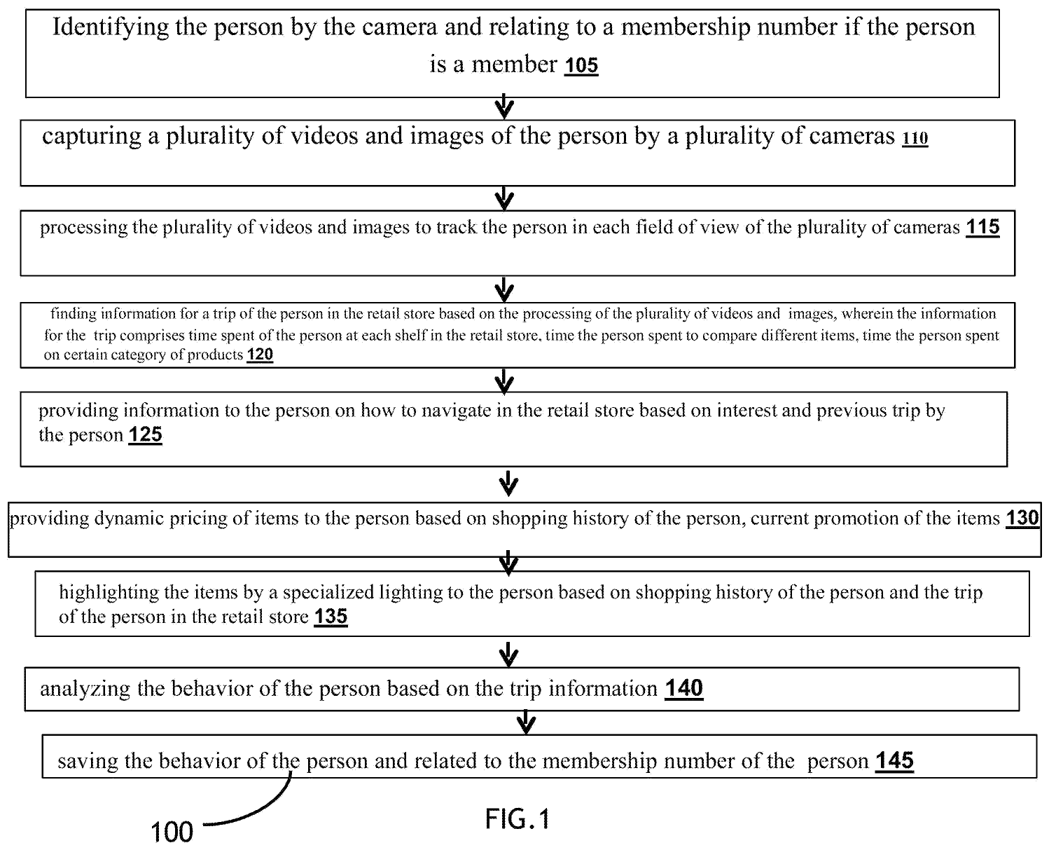

FIG. 1 shows an example of a method for simulating and analyzing the behavior of at least a person in a retail store.

In some embodiments, the invention is related to a method 100 for simulating and analyzing the behavior of at least a person in a retail store, the method comprising a step 105 of identifying the person by the camera and relating to a membership number if the person is a member.

In some embodiments, the method comprises a step of 110 of capturing a plurality of videos and images of the person by a plurality of cameras.

In some embodiments, the method comprises a step of 115 of processing the plurality of videos and images to track the person in each field of view of the plurality of cameras.

In some embodiments, the method comprises a step of 120 of finding information for a trip of the person in the retail store based on the processing of the plurality of videos and images, wherein the information for the trip comprises time spent of the person at each shelf in the retail store, time the person spent to compare different items, time the person spent on certain category of products.

In some embodiments, the method comprises a step of 125 of providing information to the person on how to navigate in the retail store based on interest and previous trip by the person.

In some embodiments, the method comprises a step of 130 of providing dynamic pricing of items to the person based on shopping history of the person, current promotion of the items.

In some embodiments, the method comprises a step of 135 of highlighting the items by a specialized lighting to the person based on shopping history of the person and, the trip of the person in the retail store.

In some embodiments, the method comprises a step of 140 of analyzing the behavior of the person based on the trip information.

In some embodiments, the method comprises a step of 145 of saving the behavior of the person and related to the membership number of the person.

In some embodiments, the current promotions of the items comprise promotions based on seasons.

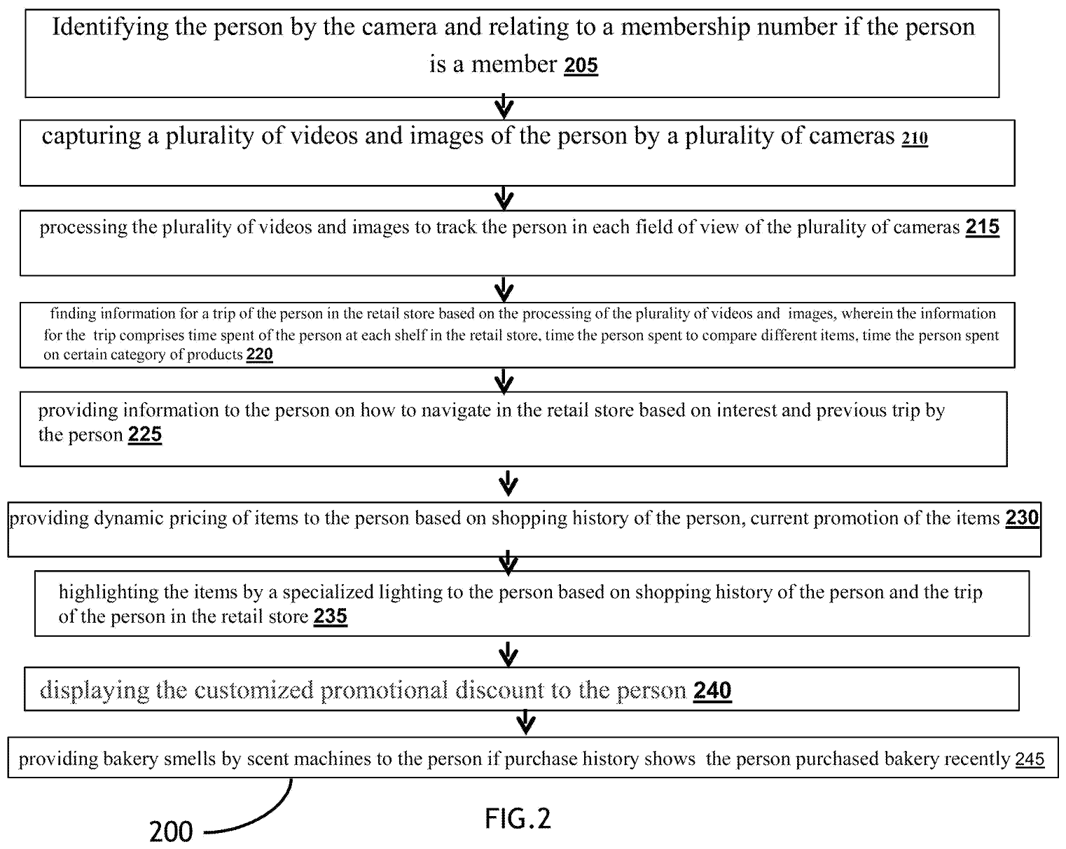

FIG. 2 shows an example of another method 200 for simulating and analyzing the behavior of at least a person in a retail store, the method comprising a step 205 of identifying the person, by the camera and relating to a membership number if the person is a member.

In some embodiments, the method comprises a step of 210 of capturing a plurality of videos and images of the person by a plurality of cameras.

In some embodiments, the method comprises a step of 215 of processing the plurality of videos and images to track the person in each field of view of the plurality of cameras.

In some embodiments, the method comprises a step of 220 of finding information for a trip of the person in the retail store based on the processing of the plurality of videos and images, wherein the information for the trip comprises time spent of the person at each shelf in the retail store, time the person spent to compare different items, time the person spent on certain category of products.

In some embodiments, the method comprises a step of 225 of providing information to the person on how to navigate in the retail store based on interest and previous trip by the person.

In some embodiments, the method comprises a step of 230 of providing dynamic pricing of items to the person based on shopping history of the person, current promotion of the items.

In some embodiments, the method comprises a step of 235 of highlighting the items by a specialized lighting to the person based on shopping history of the person and the trip of the person in the retail store.

In some embodiments, the method comprises a step of 240 of displaying the customized promotional discount to the person.

In some embodiments, the method comprises a step of 245 of providing bakery smells by scent machines to the person if purchase history shows the person purchased bakery recently.

In some embodiments, the current promotions of the items comprise promotions based on seasons.

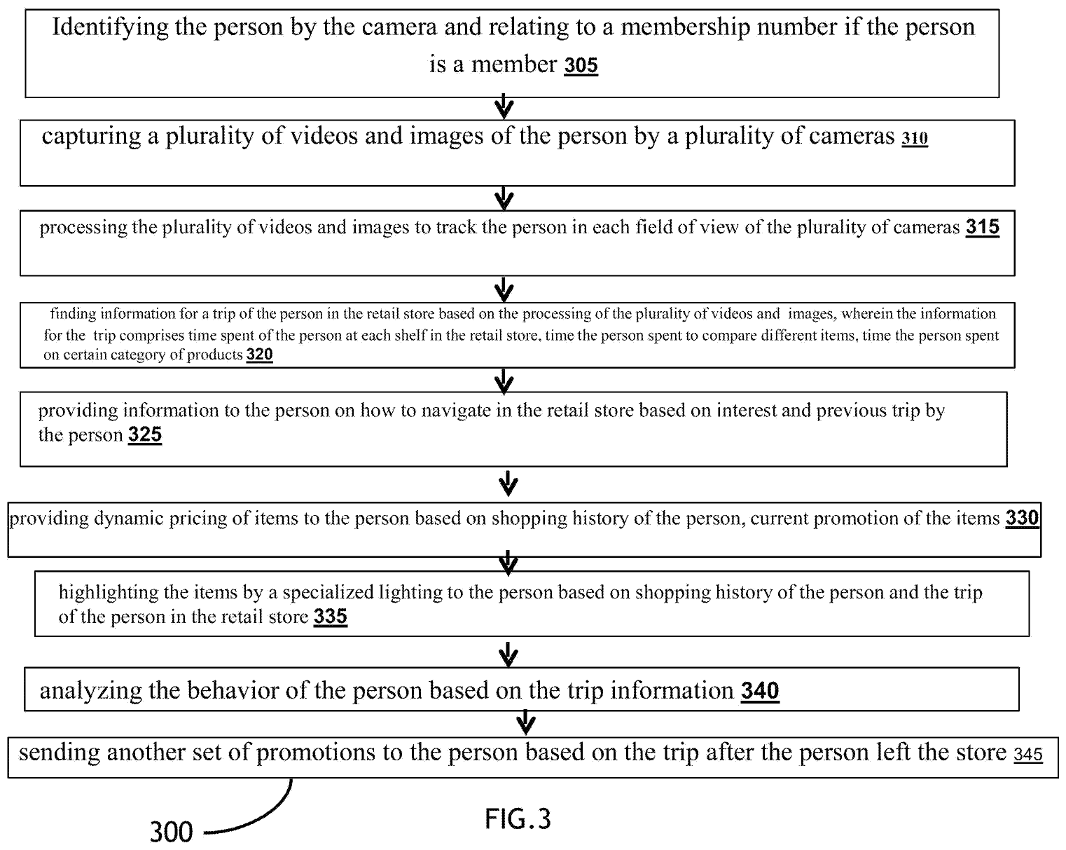

FIG. 3 shows another example of a third method 300 for simulating and analyzing the behavior of at least a person in a retail store, the method comprising a step 305 of identifying the person by the camera and relating to a membership number if the person is a member.

In some embodiments, the method comprises a step of 310 of capturing a plurality of videos and images of the person by a plurality of cameras.

In some embodiments, the method comprises a step of 315 of processing the plurality of videos and images to track the person in each field of view of the plurality of cameras.

In some embodiments, the method comprises a step of 320 of finding information for a trip of the person in the retail store based on the processing of the plurality of videos and images, wherein the information for the trip comprises time spent of the person at each shelf in the retail store, time the person spent to compare different items, time the person spent on certain category of products.

In some embodiments, the method comprises a step of 325 of providing information to the person on how to navigate in the retail store based on interest and previous trip by the person.

In some embodiments, the method comprises a step of 330 of providing dynamic pricing of items to the person based on shopping history of the person, current promotion of the items.

In some embodiments, the method comprises a step of 335 of highlighting the items by a specialized lighting to the person based on shopping history of the person and the trip of the person in the retail store.

In some embodiments, the method comprises a step of 340 of analyzing the behavior of the person based on the trip information

In some embodiments, the method comprises a step of 345 of sending another set of promotions to the person based on the trip after the person left the store.

In some embodiments, the current promotions of the items comprise promotions based on seasons.

1. A method for analyzing the behavior of at least a person in a retail store, comprising:
identifying the person by a camera and relating the person to a membership number;
capturing a plurality of videos and images of the person by a plurality of cameras;
processing the plurality of videos and images to track the person in each field of view of the plurality of cameras;
finding information for a trip of the person in the retail store based on the processing of the plurality of videos and images, wherein the information for the trip comprises time spent of the person at each shelf in the retail store, and time the person spent to compare different items, and time the person spent on certain category of products;
providing information to the person on how to navigate in the retail store based on interest and previous trip by the person;
providing dynamic pricing of items to the person based on shopping history of the person and current promotions associated with the items;
highlighting the items by a lighting to the person based on shopping history of the person and the trip of the person in the retail store;
analyzing the behavior of the person based on the trip information; and
saving the behavior of the person and related the person to the membership number of the person.

2. A method for analyzing the behavior of at least a person in a retail store of claim 1, wherein the current promotions of the items comprise promotions based on seasons.

3. A method for analyzing the behavior of at least a person in a retail store, comprising:
Identifying a person by the camera and relating to a membership number if the person is a member;
capturing a plurality of videos and images of the person by a plurality of cameras;
processing the plurality of videos and images to track the person in each field of view of the plurality of cameras;
finding information for a trip of the person in the retail store based on the processing of the plurality of videos and images, wherein the information for the trip comprises time spent of the person at each shelf in the retail store, and time the person spent to compare different items, and time the person spent on certain category of products;
providing information to the person on how to navigate in the retail store based on interest and previous trip by the person;
providing dynamic pricing of items to the person based on shopping history of the person and current promotions associated with the item;
highlighting the items by a lighting to the person based on shopping history of the person and the trip of the person in the retail store;
displaying a customized promotional discount to the person; and
providing bakery smells by scent machines to the person if purchase history shows the person purchased bakery.

4. A method for analyzing the behavior of at least a person in a retail store of claim 3, wherein the current promotions of the items comprise promotions based on seasons.

5. A method for analyzing the behavior of at least a person in a retail store, comprising:
Identifying a person by the camera and relating to a membership number if the person is a member;
capturing a plurality of videos and images of the person by a plurality of cameras;
processing the plurality of videos and images to track the person in each field of view of the plurality of cameras;
finding information for a trip of the person in the retail store based on the processing of the plurality of videos and images, wherein the information for the trip comprises time spent of the person at each shelf in the retail store, and time the person spent to compare different items, and time the person spent on certain category of products;
providing information to the person on how to navigate in the retail store based on interest and previous trip by the person;
providing dynamic pricing of items to the person based on shopping history of the person and current promotions associated with the items;
highlighting the items by a lighting to the person based on shopping history of the person and the trip of the person in the retail store;
analyzing the behavior of the person based on the trip information; and
sending another set of promotions to the person based on the trip after the person left the store.

6. A method for analyzing the behavior of at least a person in a retail store of claim 5, wherein the current promotions of the items comprise promotions based on seasons.
